(19) United States
(12) Patent Application Publication
(10) Pub. No.: US 2015/0230624 A1
(43) Pub. Date: Aug. 20, 2015

(54) Bumper Pad Device

(71) Applicant: Kathleen Peterson, Hastings, MN (US)

(72) Inventor: Kathleen Peterson, Hastings, MN (US)

(21) Appl. No.: 14/623,219

(22) Filed: Feb. 16, 2015

Related U.S. Application Data
(60) Provisional application No. 61/939,981, filed on Feb. 14, 2014.

(51) Int. Cl. A47D 15/00; F16F 7/01

(52) U.S. Cl. CPC A47D 15/005; F16F 7/01

(57) ABSTRACT

A bumper pad device is provided that comprises an elongated body portion, a pair of flaps, and fasteners for securing the flaps to one or more wall surfaces. The flaps include an interior surface supporting a first fastener, whereby a separate, elongated surface is first affixed to a wall surface and used to support a complimentary second fastener that secures the flap thereto. The flaps are connected to the body portion in a pivotable relation such that the flaps can secure around exposed edges of walls or around the corners of interior entryways. The pad body portion supports a filler material therein to attenuate impacts, and is ideally suited to protect young children from injury upon impact with walls, corners, and door frames. The exterior surface of the bumper pad device may include ornamental adornments and indicia suitable for use with children.

### CROSS REFERENCE TO RELATED APPLICATION

This application claims the benefit of U.S. Provisional Application No. 61/939,981 filed on Feb. 14, 2014. The above identified patent application is herein incorporated by reference in its entirety to provide continuity of disclosure.

### BACKGROUND OF THE INVENTION

### Field of the Invention

The present invention relates to bumper pads and protective devices for furniture and indoor surfaces. More specifically, the present invention relates to a child protective device that secures to the interior surface of a door frame or entryway frame and provides a padded, yet decorative surface that prevents a child from impacting the frame when playing.

Children often run throughout the house while playing and are known to injure themselves by impacting various articles of furniture and interior structures. Protective devices are available for padding the various surfaces of a home and for covering potentially hazardous items that a you child may contact in the home. These generally include pads for the corners of furniture and the like. The present invention provides a new bumper pad device that is suited for attachment to the interior frame of a door or entryway.

The present invention is particularly suited for children playing in a doorway jumper assembly, whereby a young child is positioned within a harness that is suspended from the vertical portion of a doorway such that the child can jump and be supported by the apparatus without completely falling to the ground. These are popular items for young children who cannot walk yet and who are building leg strength. It is contemplated that the present invention be deployed along the adjacent vertical portions of the doorway frame to prevent inadvertent impacts therewith while the child is in such a device. Moreover, the present invention contemplates decorative and functional features on the outer surfaces of its construction that are appealing to young children.

The present invention comprises a bumper pad device that is affixable around a rectangular or rounded wall, and particularly around an exposed doorway or entryway frame. The assembly comprises a body portion, a pair of extended flaps, and a connector system that secures the assembly to the exposed frame. The pad is a cushioned member having a thickness and an interior batting that reduces the energy of impacts when a child inadvertently falls or jumps towards the frame and would otherwise be injured. The limited example of use with doorway frames and while a child is in a jumping assembly is considered a non-limiting example, and one of many applications considered falling within the scope of the claimed invention.

### SUMMARY OF THE INVENTION

The following summary is intended solely for the benefit of the reader and is not intended to be limiting in any way. The present invention provides a new bumper pad device that is particularly suited for attachment to interior wall structures and can be utilized for providing convenience for the user when protecting young children, pets, and other users from injury upon inadvertent impact with a doorway frame or similar interior feature.

It is therefore an object of the present invention to provide a new and improved bumper pad device that has all of the advantages of the prior art and none of the disadvantages.

It is another object of the present invention to provide a bumper pad device that is affixable to the surface of an interior structure and is well suited for securing corners or edges of a doorway, entryway, or similar interior corner.

Another object of the present invention is to provide a bumper pad device having a body portion that is padded and includes flared flaps that extend outward and are fastened to a wall surface to secure the device in a static position.

Yet another object of the present invention is to provide a device that is well suited to prevent injuries to young children either learning to walk or still prone to injury while playing indoors.

Another object of the present invention is to provide a bumper pad device having an exterior surface that may adorned with various ornamental features and include colors, indicia, or three dimensional shapes that are pleasing to young children or are appropriate for the intended environment.

Another object of the present invention is to provide a bumper pad device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the bumper pad device of the present invention in an open, detached position.

FIG. 2 shows a view of the bumper pad in a typical installation location, whereby the flaps secure to fasteners that are first mounted to the wall surface and thereafter secure thereto to support the device along a planar wall or around an interior corner.

FIG. 3 shows a use of the present invention in conjunction with a common child doorway jumper assembly, whereby a pair of pads is deployed on the opposing corners of the doorway.

FIG. 4 shows an embodiment of the present invention in which the bumper pad includes surface ornamentation, indicia, and three dimensional shapes that are suited for child enjoyment.

### DETAILED DESCRIPTION OF THE INVENTION

Reference is made herein to the attached drawings. Like reference numerals are used throughout the drawings to depict like or similar elements of the bumper pad device of the present invention. For the purposes of presenting a brief and clear description of the present invention, the preferred embodiment will be discussed as used for preventing child injury upon contact with a wall surface, whereby the bumper pad device provides a protective layer along a wall surface, around an interior corner, or around an exposed wall or interior frame. The figures are intended for representative purposes only and should not be considered to be limiting in any respect.

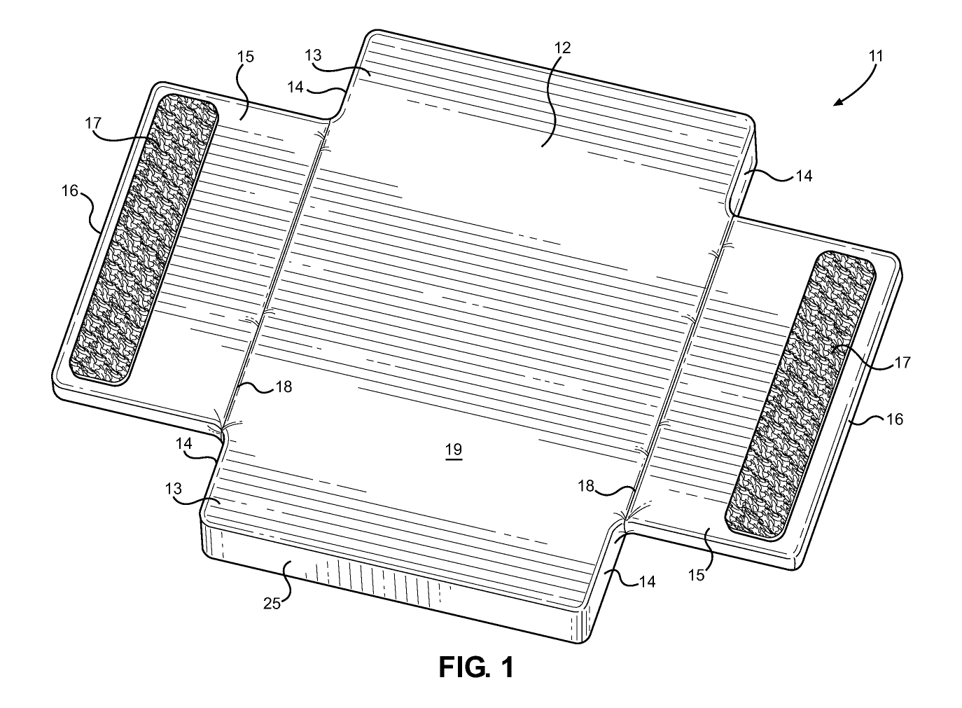

Referring now to FIG. 1, there is shown a perspective view of the bumper pad device 11 of the present invention in an open and planar state. The bumper pad device 11 comprises a padded member that is configured to be supported by fasteners to a wall surface, either along a planar surface or around a corner within the interior of a home. The bumper pad device 11 comprise a thickness 25 is filled with a filler material that acts as a cushion or pad when impacted by objects or falling children. The impacts are attenuated as the filler material is compressed, thereby reducing energy transfer to the falling child or damage to the wall that would otherwise result if the wall or corner was not covered by the device 11.

The bumper pad device 11 comprises an elongated body portion 12 that is preferably a substantial rectangular shape. The pad body portion 12 comprises an elongated length with a pair of sides 14, an outer surface, an interior surface 19, an exterior surface, a thickness, and a width. Between the interior 19 and exterior surfaces is an enclosed interior volume that supports the filler material therein. Extending from the sides 14 of the body portion 12 are a pair of flaps 15, which extend substantially orthogonally from the body portion sides 14 such that the body portion 12 and the flaps 15 forma substantial X-shaped bumper pad device 11.

The flaps 15 include an elongated length that is parallel to the length of the body portion. The flaps 15 are preferably rectangular members having an outer edge 16, an interior surface, and an inner edge 18 that aligns with the side 14 of the body portion 12. The intersection of the flap inner edge 18 with the body portion sides 14 is a pivotable connection, whereby each flap 15 can rotate relative to the body portion 12 such that the flaps can secure around corners or remain in plane with the body portion. The pivotable relation between the flaps 15 and the body portion 12 along the inner edge 18 is preferably a stitched formation that prevents the filler material of the body portion 12 from moving into the flap portions and interfering with the pivotable relation therebetween. The flaps 15 may comprises an interior volume, or alternatively may comprises a more flattened construction relative to the padded body portion 12, which supports the filler material within its interior volume to fill out its thickness and attenuation impact energy when contacted.

The body portion length preferably extends beyond the extents of the flaps 15, whereby the body portion 12 comprises an upper and lower portion 13 extended above the extent of each flap 15. Therefore, the flaps 15 include a length that runs along the length of the body portion, however the padded body portion 12 is one that fulfills a protective function and therefore must extend further along the wall surface to protect the same and to protect those that would contact the wall. The flaps 15, in contrast, are designed to support an elongated fastener 17 that connects the bumper pad device 11 to the wall surfaces. The shape of the bumper pad device 11 is therefore X-shaped with a pair of opposing flaps 15, a central pad body portion 12 that extends above and below the extent of the flaps 15, and whereby the flaps 15 are pivotably attached to the body portion sides 14.

Disposed along the interior surface of each flap 15 is one or more fasteners 17. This first fastener 17 is one that is configured to have a complimentary second fastener supported on an adjacent wall surface. The first fastener 17 is removably connected to the second fastener, and the second fastener is supported along the wall surface by a wall fastener. The wall fastener is one that is supported along an elongated surface and positioned along the wall such that the flaps 16 can be secured thereto using the corresponding fasteners. Once the corresponding fasteners are joined, the device 11 is supported in a static position on a wall, around a door frame, or around an exposed corner.

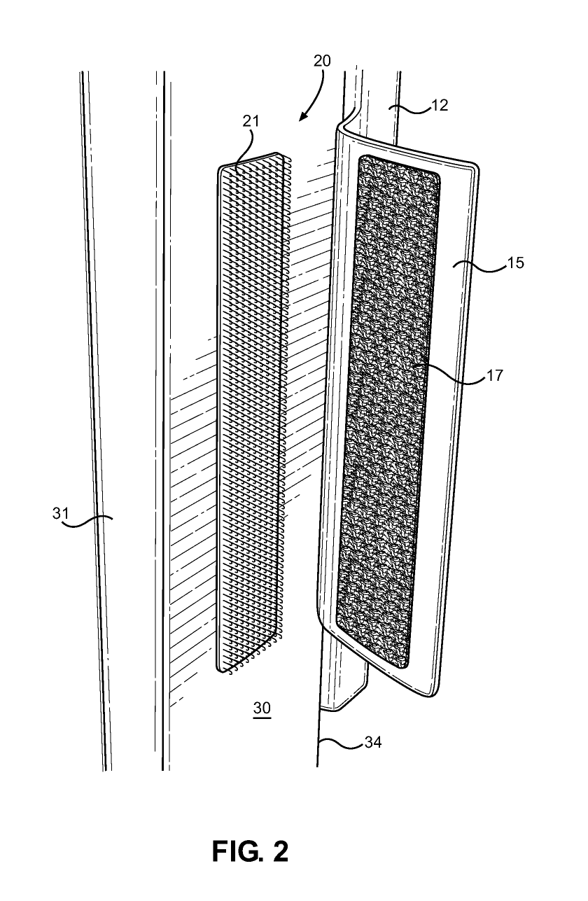

Referring now to FIG. 2, there is shown a view of the bumper pad device being secured to a wall surface 30 using the flaps 15. The flaps 15 include an interior surface having a first fastener 17 thereon. The first fastener 17 is preferably a strip of hook and loop fastening material; however the first fastener 17 may also comprise snaps, buttons, hooks, or the like. Several equivalent fasteners are contemplated along the flaps 15 to secure the flaps to a wall surface 30. In the preferred embodiment and for the purposes of clarity, the first fastener and the complimentary second fastener 21 will be discussed as being hook and loop. Supported along the wall surface 30 is an elongated surface 20 supporting a complimentary fastener 21 thereon. The complimentary fastener 21 is one that is complimentary and makes secure connection with the first fastener 15 along the interior surface of the flaps 15. This second fastener 21 shares a construction that allows attachment and is complimentary or similarly congruent to chosen fastener along the flap interior surface.

The elongated surface 20 is supported along a wall surface 30 and is positioned such that the first fastener 17 will make contact with the second fastener 21 when the pad body portion 12 is positioned as desired along the wall or around the corner 34 of a wall or entryway frame 31. The elongated surface 20 comprise a first side supporting the second fastener 21 thereon, and a second surface supporting a wall fastener thereon. The wall fastener is one that is configured to make contact and secure against the surface 30 of a wall and prevent the elongated surface 20 from detaching therefrom. In turn, the wall fastener ensures the flap 15 will remain connected to the wall surface 30 when the first fastener 17 and the complimentary second fastener 21 make connection. It is preferred that the wall fastener have a grip strength greater than the grip strength between the first fastener 17 and the second fastener 21, thereby facilitating placement of the elongated surface 20 on a wall surface and allowing the user to remove the flaps 15 and the pad from the wall without also removing the elongated surface 20. In this way, the mounting system for the bumper pad assembly can remain in place even if the bumper pad device is temporarily removed. Contemplated wall fasteners include adhesive, physical fasteners, or the like. Any fastener with a greater grip strength that will not separate from the wall when the flap 15 is forcibly pulled from the elongated strip will fulfill this objective.

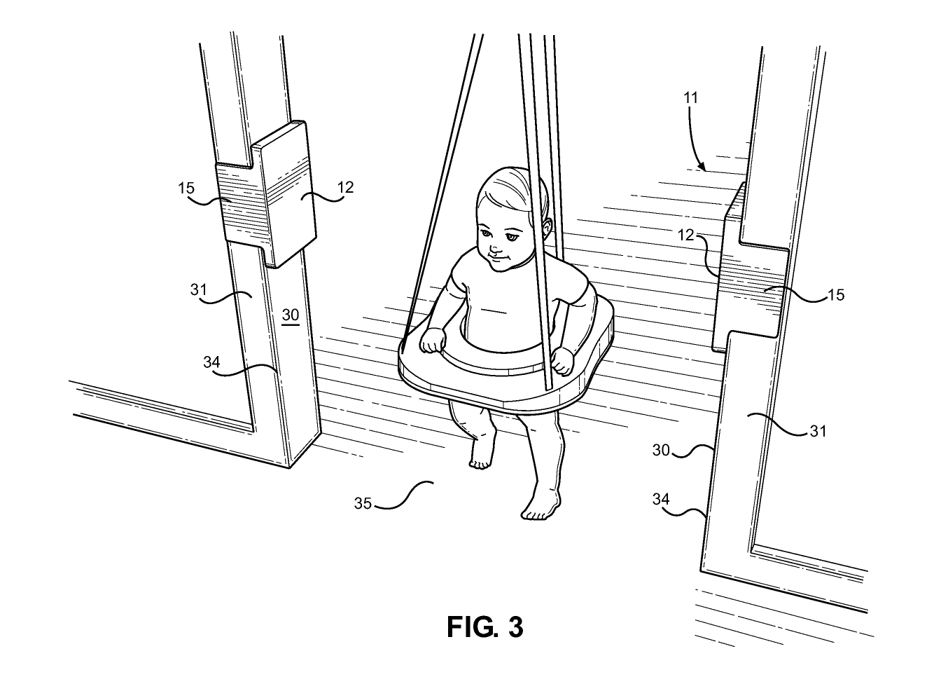

As shown in FIGS. 2 and 3, the bumper pad device 11 of the present invention is well suited for protecting wall surfaces around corners 34 and along door frames 31. The flaps 15 extend around the corners 34 and affix to a wall or frame 31, while the pad body portion 12 is disposed along the desired wall 30 adjacent thereto. This is particularly useful for protecting exposed corners, and even more so for protecting exposed portions of walls or entryway frames as depicted in FIG. 3. A contemplated use includes use of the bumper pad device 11 in a set of two, whereby the interior surfaces 30 of an entryway frame or door frame 31 are protected as a child plays within the interior 35 of the frame. This includes general playing, and playing in a doorway jumper assembly suspended from the upper portion of the entryway frame.

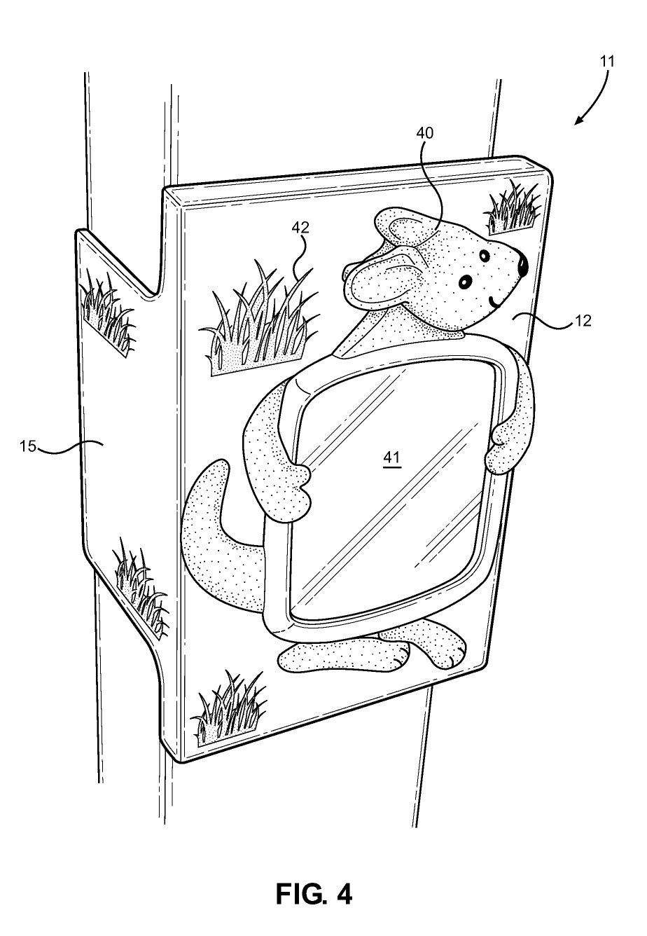

Referring now to FIG. 4, there is shown a perspective view of the bumper pad device 11 in a working state and in an exemplary embodiment that is suited for child protective use. The device 11, along the body portion 12 and along the flaps 15, may include surface indicia 42 that is suited to please the user (a child, for instance) or to suit the interior arrangement of the home. Further provided may be three dimensional shapes and characters 40, which protrude from the outer surface of the body portion. These three dimensional projections are padded members, either comprising a foam construction or a filler material filled material. Finally, the body portion may support a reflective mirror surface 41. It is contemplated that surface adornments, patterns, and surface indicia will improve the ornamental qualities of the bumper pad device 11, particularly when the intended use is to protect children. The bumper pad device 11 may therefore support the function of energy attenuation, while also supporting the function of child entertainment.

Overall it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A bumper pad device affixable to one or more adjacent surfaces, comprising:
a pad body portion having a substantially rectangular shape with a length, an interior surface, an exterior surface, a width, a thickness between the interior surface and the exterior surface, an interior volume, and a pair of sides;
the interior volume of the pad having a filler material disposed therein that is sufficient to attenuate energy when an impact depresses the interior surface towards the exterior surface;
a first and second flap extending outward from each of the sides of the pad body portion;
the first and second flap being in pivotable relative to the pad body portion;
the first and second flap each having an interior surface with a first fastener disposed thereon;
a second fastener that corresponds with the first fastener and removably attachable thereto;
whereby the second fastener is disposed on an elongated surface separate from the pad body portion, the elongated surface having a first side supporting the second fastener, and a second side supporting a wall fastener thereon;
the wall fastener being configured to secure the elongated surface to a planar surface and remain affixed to the planar surface when the first fastener is pulled away from the second fastener.

2. The bumper pad device of claim 1, wherein:
the first and second flap each having a flap length that is parallel to the length of the pad body portion
the length of the pad body portion being greater than the length of the first and second flaps;
the first and second flap extending orthogonally outward from the pad body portion to form a substantial X-shape.

3. The bumper pad device of claim 1, wherein:
between each flap and each side of the pad body portion is a sewn line of connection that prevents the filler material from moving from the interior volume of the pad body portion and into the first and second flap to facilitate the pivotable relative between the first and second flap and the sides of the pad body portion.

4. The bumper pad device of claim 1, wherein:
the wall fastener of the elongated surface has a grip strength greater than the grip strength between the first fastener and second fastener.

5. The bumper pad device of claim 1, wherein the wall fastener of the elongated surface comprises an adhesive material.

6. The bumper pad device of claim 1, wherein the first fastener and the second fastener comprise complimentary hook and loop fasteners.

7. The bumper pad device of claim 1, wherein the exterior surface of the pad body portion comprises surface indicia.

8. The bumper pad device of claim 1, wherein the exterior surface of the pad body portion comprises three dimensional ornamentation thereon.

9. The bumper pad device of claim 1, wherein the exterior surface of the pad body portion comprises a mirrored surface.
